(19) United States
(12) Patent Application Publication
(10) Pub. No.: US 2003/0195773 A1
(43) Pub. Date: Oct. 16, 2003

(54) Method for payment of healthcare costs

(76) Inventor: Robert G. Mahaffey, Davenport, FL (US)

Correspondence Address: John L DeAngelis Jr Esq, Beusse Brownlee Bowdoin & Wolter PA, 390 N Orange Ave Suite 2500, Orlando, FL, 32801, US

(21) Appl. No.: 10/174,911

(22) Filed: Jun. 19, 2002

Related U.S. Application Data
(60) Provisional application No. 60/372,552, filed on Apr. 15, 2002.

(51) Int. Cl. G06F 17/60

(52) U.S. Cl. 705/3

(57) ABSTRACT

A method for payment of healthcare charges. The patient pays the amount due with a healthcare credit card and in return receives a first discount from the amount due. The credit card issuing company pays the healthcare provider an amount equal to the patient charge less the first and less a second discount. The credit card issuing company collects from the patient an amount equal to the amount charged less the first discount. The healthcare provider minimizes its accounts receivable, the patient receives a discount from the amount due and the charge card issuer earns a profit due to a payment to the healthcare provider of a double discounted amount while collecting from the patient a single discounted amount.

This patent application claims the benefit of the U.S. provisional patent application filed on Apr. 15, 2002, and assigned Application No. 60/372,552.

### FIELD OF THE INVENTION

This invention relates generally to the field of healthcare services, and more specifically to a method for executing the various financial transactions associated with the payment for these healthcare services.

### BACKGROUND OF THE INVENTION

With rising healthcare costs and increasing patient visits, today's healthcare providers often retain significant accounts receivable for the services provided. These receivables are created by the time lag between provision of the service and reimbursement by the insurance carrier, as well as delays in receiving the payment from the patient for any amounts for which she is responsible. The cost of administering and collecting these accounts receivable represents a considerable resource allocation by the provider. Also, the carrying costs generated by these receivables represents a sizable expense for the provider. All healthcare providers, including hospitals, physicians, laboratories, ambulatory surgery centers, diagnostic centers and clinics are subject to these cost of doing business.

Typically, when a patient receives healthcare services, she is expected to pay any amount not covered by insurance at the time the services are rendered. The payment is generally in the form of a personal check drawn on the patient's bank account or by credit card. In the former case, the check can take several days to clear before the corresponding deposit is made into the provider's bank account. Credit card transactions are typically processed faster and thus the deposit is credited to the provider's account earlier than payments by check. Cash payments result in immediate revenue to the provider, but today, few patients pay for their healthcare services with cash.

The healthcare provider processes the credit card payment, thereby notifying the credit card issuer that the patient has charged the amount due to the credit card. Within a few days this amount is debited to the patient's account and the provider's bank account is credited with the amount charged by the patient. The transaction is finally concluded when the patient pays the credit card issuer for the healthcare service. If this payment is not received within an allotted time, interest charges are assessed against the card holding patient.

### SUMMARY OF THE INVENTION

The prior art process offers no incentives to the parties involved in the healthcare financial transaction to act with dispatch so that the transaction can be quickly concluded and the provider paid in a timely manner. As a result, healthcare providers often retain significant accounts receivable. The present invention offers discount incentives in return for early payment by the parties. For example, the portion of the charge that is the patient's responsibility is discounted if the patient pays by credit card when the service is rendered. The provider is paid for the services by the credit card issuer, and this payment is also discounted.

### BRIEF DESCRIPTION OF THE DRAWINGS

The foregoing and other features of the invention will be apparent from the following more particular description of the invention, as illustrated in the accompanying figures, in which,

FIGS. 1 and 2 illustrate methods for paying for healthcare services according to the teachings of the present invention.

### DETAILED DESCRIPTION OF THE INVENTION

Before describing in detail the particular method in accordance with the present invention, it should be observed that the present invention resides primarily in a novel combination of method steps. Accordingly, the elements of the invention have been represented by conventional elements in the drawing, showing only those specific details that are pertinent to the present invention, so as not to obscure the disclosure with details that will be readily apparent to those skilled in the art having the benefit of the description herein.

According to the teachings of the present invention, a method for paying healthcare costs that reduces the provider's accounts receivable and ensures timely collection of the patient's bill is presented. The process involves a new and non-obvious series of financial transactions between the patient, the healthcare provider and a credit card issuing organization.

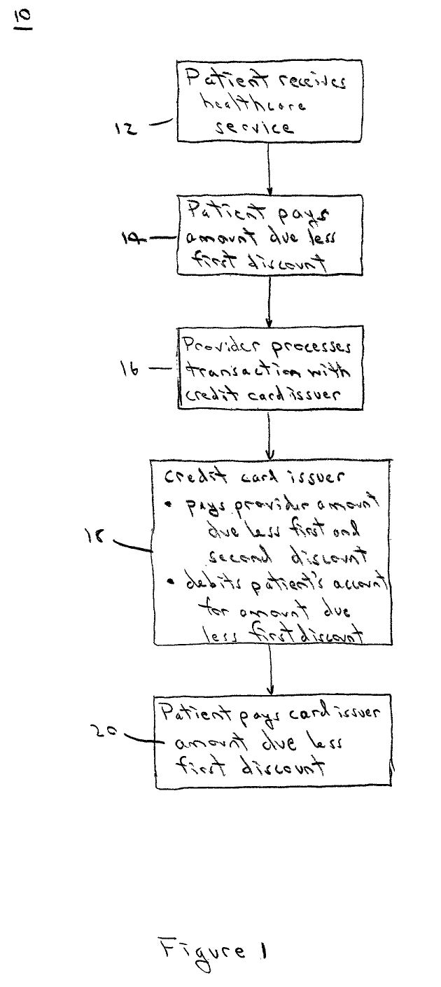

The various steps of the healthcare payment process 10 according to the present invention are illustrated in the flowchart of FIG. 1. After the patient receives the healthcare services at a step 12, the patient's insurance carrier, if any, pays the provider a predetermined fee or percentage of the amount charged for the services. If the patient elects to pay the amount for which she is responsible, i.e., the co-pay or any amount that is not covered by insurance, with a healthcare credit card, the provider offers a discount from the amount for which the patient is responsible. In one embodiment, the discount is 10%. The discount offer motivates the patient to pay the full amount for which he is responsible immediately after the services are rendered, as the discount will not be available thereafter. However, the discount is applied only when the patient uses the healthcare credit card. The discount does not apply to payment in cash, by check or with a non-healthcare credit card. The patient pays the discounted amount with the healthcare credit card as shown at a step 14.

Alternatively, the healthcare credit card features can be associated with a general issue credit card. The card issuer can charge an enrollment fee for a credit card that includes these features.

The provider processes the patient's credit card transaction through its billing system to the charge card issuer, as shown at a step 16. A prior arrangement between the charge card issuer and the healthcare provider allows for the application of a second discount from the amount charged to the patient. In one embodiment of the present invention the second discount is also 10%. Therefore, the card issuer credits the provider's bank account with an amount equal to the patient responsibility amount, less the first discount offered to the patient and the second discount offered to the provider. See a step 18. Although the provider does not receive the full amount of the patient's responsibility, the discounted amount is credited within a relatively short period of time after the services are rendered, typically within a few hours. Thus the provider has achieved nearly immediate payment of the patient's share of the amount due, albeit at the expense of a discount. However, if the discount amount is judiciously chosen, the provider has a net positive gain due to the avoidance of carrying and administrative costs associated with its accounts receivable.

The healthcare charge card issuer debits the patient's credit card account for the amount of the patient's responsibility less the first discount. This debit step is also indicated at the step 18. After the patient pays the charge card invoice (at a step 20), the card issuer is in a net positive position, having paid the provider an amount equal to the patient's responsibility less two discounts, while receiving the amount for which the patient is responsible less one discount. Thus the card issuer has received compensation for carrying the transaction through the process of paying the provider prior to receipt of payment from the patient.

All parties in the transaction accrue a benefit not available according to the prior art payment methodologies. The healthcare provider receives near-immediate payment of the amount for which the patient is responsible, less a first and a second discount. The patient earns the first discount from the amount for which she is responsible, in return for immediate payment with a healthcare credit card. The card issuing company debits the patient's credit card account with the amount billed and therefore expects to receive this amount from the patient at the end of the billing cycle, plus interest if the charge is not paid in the allotted time. Also, the credit card issuer credits the provider's bank account with the amount billed to the patient less a second discount. Thus the gain attributed to the card issuer is the difference between the amount collected from the patient and the amount credited to the provider.

All healthcare providers can benefit from the teachings of the present invention, including hospitals, physicians, dentists, laboratories, ambulatory surgery and diagnostic centers, hospice centers, assisted living facilities, nursing homes, clinics and rehabilitation centers. The concepts can also be applied to dispensing of prescription drugs by pharmacies. Conventional credit card issuers would be motivated to issue such healthcare credit cards in return for the increased gain over what they would typically earn in credit card usage fees from healthcare providers.

Although explained in conjunction with the rendering of a healthcare service where an insurance carrier covers a portion of the service cost, the teachings of the present invention are also applicable to a situation that does not involve an insurance carrier and insurance payments. In this situation, rather than the patient having responsibility for a predetermined share of the total charges, and receiving a discount therefrom, the patient is responsible for the total charge and receives a discount from this amount.

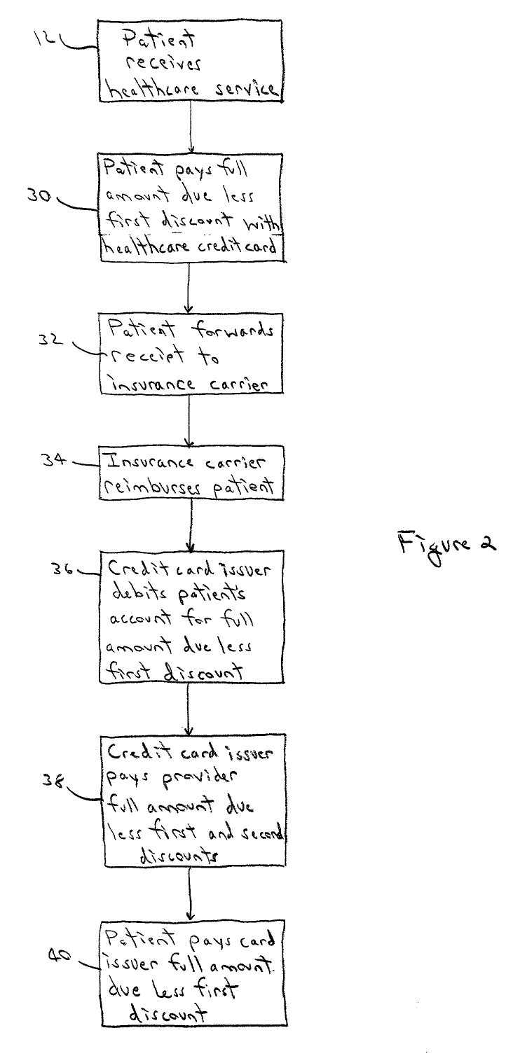

According to another embodiment of the invention, healthcare financial transactions involving an insurance carrier can also offer discounts in return for early payments. According to this embodiment, as illustrated in FIG. 2, the patient uses a healthcare credit card to pay the entire amount due for the services rendered, less a first discount. See a step 30. At a step 32, the patient forwards the payment receipt to the insurance carrier for reimbursement. Reimbursement is made by the insurance carrier to the patient of the entire charge for the service, less the first discount. See a step 34. The credit card issuer debits the patient's account with this same amount at a step 36. The credit card issuer also pays the provider the amount due for the service less the first and a second discount at a step 38. Finally, the patient pays her credit card bill at a step 40. As in the previous embodiment, the credit card issuer receives an amount (the charge less the first discount) that is greater than the amount it paid to the provider (the charge less the first and the second discount). Advantageously, both the patient and the insurance carrier receive a discount from the total charge for the healthcare service. The provider receives earlier payment from the charge card issuer than is typically received from an insurance carrier. The teachings of this embodiment can also be applied to the amount for which the insurance carrier is responsible under a predetermined arrangement with the provider, rather than the full amount of the charge, as described above.

While the invention has been described with reference to preferred embodiments, it will be understood by those skilled in the art that various changes may be made and equivalent elements may be substituted for elements thereof without departing from the scope of the present invention. The scope of the present invention further includes any combination of the elements from the various embodiments set forth herein. In addition, modifications may be made to adapt a particular situation to the teachings of the present invention without departing from its essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method by which a patient pays for healthcare services provided by a healthcare provider with a credit card issued by an issuing party, said method comprising:
(a) the patient paying the amount due for the healthcare services, less a first discount, with the credit card; and
(b) the issuing party paying the provider for the healthcare services in an amount equal to the amount due less the first discount and less a second discount;
(c) the issuing party debiting the patient's credit card account with the amount due less the first discount.

2. The method of claim 1 wherein step (b) is executed within a relatively short time of the execution of the step (a).

3. The method of claim 1 wherein the amount due is the patient's co-pay amount.

4. The method of claim 1 wherein the healthcare service comprises dispensing prescription drugs.

5. The method of claim 1 further comprising:
(d) the patient submitting a receipt for the amount due less the first discount to an insurance carrier;
(e) the insurance carrier reimbursing the patient for the amount due less the first discount, less any amount that is the patient's responsibility.
